(19) United States
(12) Patent Application Publication
(10) Pub. No.: US 2008/0161067 A1
(43) Pub. Date: Jul. 3, 2008

(54) Method and apparatus for wireless dialing

(75) Inventors: Kenneth John Reda, San Juan Capistrano, CA (US); Jean Louis Domerego, Irvine, CA (US)

Correspondence Address: CROWELL & MORING LLP;INTELLECTUAL PROPERTY GROUP, P.O. BOX 14300, WASHINGTON, DC, 20044-4300, US

(73) Assignee: Seamless Wi-Fi, Inc., Las Vegas, NV (US)

(21) Appl. No.: 11/649,495

(22) Filed: Jan. 3, 2007

(51) Int. Cl. H04M 1/00

(52) U.S. Cl. 455/569.1

(57) ABSTRACT

A wireless headset includes a first transceiver configured to establish a first wireless connection with the cellular-capable device, and a second transceiver configured to establish a second wireless connection with a wireless dialer. In one embodiment, the wireless headset receives user communication data transmitted over the second wireless connection from a wireless dialer, and then transmits this user communication data over the first wireless connection to the cellular-capable device.

### FIELD OF THE INVENTION

The invention relates in general to wireless communication and in particular to a wireless dialing apparatus and method.

### BACKGROUND OF THE INVENTION

Personal wireless communication technologies are rapidly being developed worldwide. Many of these technologies are based on the Bluetooth™ wireless technology developed by Ericsson Corporation in Sweden. Such technologies have enabled the widespread adoption of convenient mobile services at relatively low cost. Bluetooth™ is an industrial specification for wireless personal area networks (PANs) and provides a convenient way to connect and exchange information between devices such as mobile phones, laptops, PCs, printers and digital cameras via a relatively secure, globally unlicensed short-range radio frequency. Typically, Bluetooth™-enabled devices communicate over a distance of approximately 10 meters and have the ability to transmit both voice and data signals over a wireless link. Bluetooth™-enabled devices have included laptop computers, cellular telephones, personal digital assistants (PDAs), earpiece/headset devices and so on.

With respect to wireless headsets or earpieces which have been “paired” with a cellular device (e.g., smartphones, cellular telephones, etc.), users are able to engage in two-way communication with a third party without having to handle the cellular device itself. This convenience is particularly useful when the cellular device isn't immediately accessible, while the user is driving a vehicle, or while the user is otherwise engaged in an activity which requires the user to have two free hands. However, all such wireless headsets and earpieces heretofore have suffered from various drawbacks which impede the overall convenience of the device. For example, the cellular device must be physically handled by the user in order to place calls to all non-programmed numbers. While voice command dialing may be possible using just the wireless headset, this functionality is only applicable in the limited context of preprogrammed telephone numbers. In cases where the cellular device is inaccessible or bulky, this can be a significant inconvenience for the user.

Additionally, wireless headsets have heretofore not be designed to optimize both cellular communications as well as music listening functions. Thus, what is needed is a method and apparatus which overcome one or more of the aforementioned drawbacks.

### SUMMARY OF THE INVENTION

Disclosed and claimed herein is a method and apparatus for wireless dialing. In one embodiment, a wireless headset includes a first transceiver configured to establish a first wireless connection with the cellular-capable device, and a second transceiver configured to establish a second wireless connection with a wireless dialer. The wireless headset further includes a processor configured to cause the wireless headset to receive user communication data transmitted over the second wireless connection from the wireless dialer, and transmit the user communication data over the first wireless connection to the cellular-capable device.

Other aspects, features, and techniques of the invention will be apparent to one skilled in the relevant art in view of the following detailed description of the example embodiments of the invention.

### BRIEF DESCRIPTION OF THE DRAWINGS

FIG. 1A is a block diagram of a wireless headset designed in accordance with one embodiment of the invention;

FIGS. 1B-1C depict two views of the wireless headset of FIG. 1A;

FIG. 2 is one embodiment of a block diagram for a system which incorporates one or more aspects of the invention;

FIGS. 3A-3B depicts two views of a wireless dialer usable in the system of FIG. 2;

FIG. 4 is one embodiment of a process for carrying out certain aspects of the invention; and

FIG. 5 is another embodiment of a process for carrying out certain aspects of the invention.

### DETAILED DESCRIPTION OF THE EXEMPLARY EMBODIMENTS

The present disclosure relates in part to a method and apparatus for wireless dialing. In one embodiment, a wireless headset includes a first transceiver configured to establish a first wireless connection with the cellular-capable device, and a second transceiver configured to establish a second wireless connection with a wireless dialer. The wireless headset may be further configured to receive user communication data transmitted over the second wireless connection from the wireless dialer, and to transmit the user communication data over the first wireless connection to the cellular-capable device. In one embodiment, the cellular-capable device may be any one of a cellular telephone, smartphone, personal digital assistant and a cellular-capable computer.

In certain embodiments, the wireless headset may be configured as a single-ear headset and include a first earbud for positioning adjacent to a first user ear. The wireless headset may also include a second earbud affixed to the wireless headset on a retractable connection line, and configured for positioning adjacent to a second user ear.

The wireless headset of the present disclosure may further be configured to receive a media data stream from the cellular-capable device over the first wireless connection. In one embodiment, this media data stream may be a music stream.

Another aspect of the disclosure is a wireless dialer that includes a display and a keypad for entering the user communication data, which in certain embodiments includes a called party telephone number.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

As used herein, the term “Bluetooth™ module” refers to software and/or hardware configured to provide wireless communication between devices in accordance with the Bluetooth™ standard. Bluetooth™ is a trademark registered and refers to technology developed by an industry consortium known as the Bluetooth™ Special Interest Group. Bluetooth™ operates at a frequency of approximately 2.45 GHz, utilizes a frequency hopping (on a plurality of frequencies) spread spectrum scheme.

A control interface is typically defined between two or more Bluetooth™ modules using a passkey, for example. This process is commonly referred to as “pairing.” Once two or more devices have been “paired,” message packets associated with the prescribed interfaces are communicated freely between the corresponding Bluetooth™ modules. Additional details on the functionality of Bluetooth™ modules are readily known in the art and are beyond the scope of this disclosure.

While aspects of the present disclosure may relate to Bluetooth™ communication, it should equally be appreciated that any other known RF communication protocol could similarly be used consistently with the principles of the invention. As such, where reference is made to Bluetooth™ communications and/or modules, it should be appreciated that any other RF communication protocols may be substituted in lieu thereof.

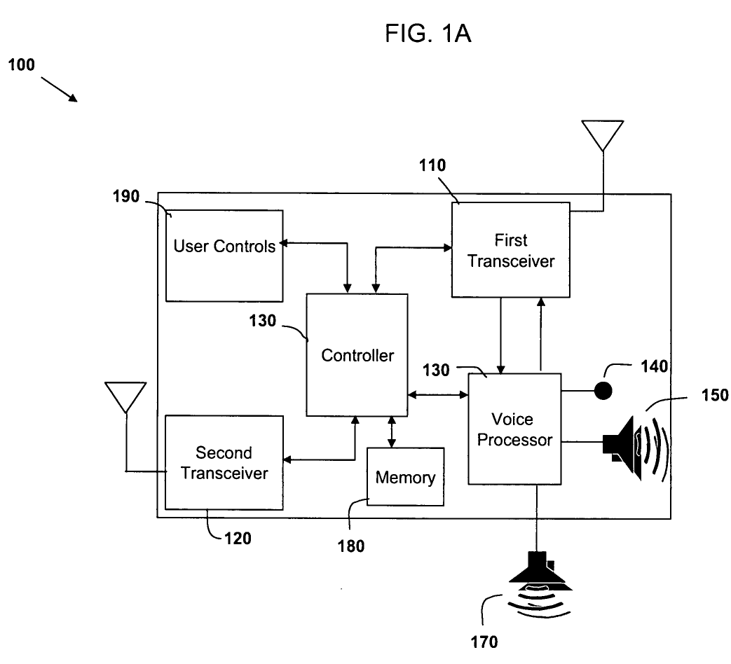

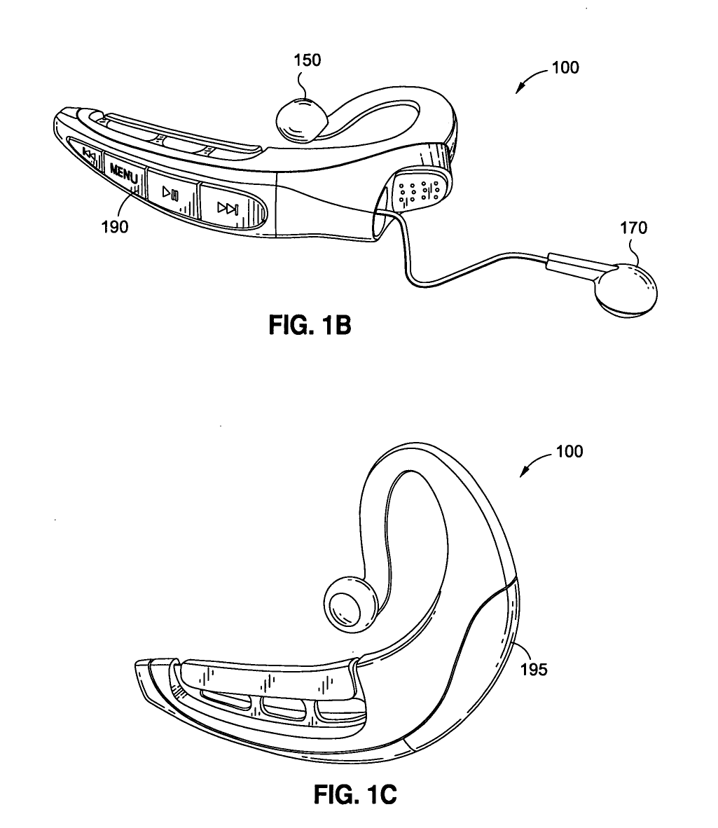

FIG. 1A is a block diagram a wireless headset 100 according to one embodiment of the invention. In one embodiment, headset 100 is configured as an earpiece. Headset 100 includes at least a first transceiver 110 and a second transceiver 120, both electrically coupled to and controlled by controller 130. While in one embodiment, both the first transceiver 110 and second transceiver 120 are RF transceivers, either may alternatively be an infrared transceiver. Moreover, one or both of the first transceiver 110 and second transceiver 120 may incorporate a Bluetooth™ module so as to enable communication with corresponding Bluetooth™ enabled devices. In one embodiment, the first transceiver 110 may be used to establish a communication link with a cellular-capable device so as to enable the headset 100 to be used for cellular communications initiated by a connected device.

Headset 100 further includes a microphone 140 and a first loudspeaker 150, both coupled to an optional voice processor 160 which communicates with the controller 130. In another embodiment, the microphone 140 and loudspeaker 150 communicate directly with the controller 130. The loudspeaker 150 may be in the form of an integrated earbud which extends into or against a user's inner ear when the headset 100 is configured as an earpiece. An optional second loudspeaker 170 is further depicted as being coupled to the voice processor 160, but may alternatively be coupled directly to the controller 130. In one embodiment, this second loudspeaker 170 may be configured as a retractable earbud usable for placing in the user's other ear (i.e., the ear opposite the headset 100). In this fashion, a user can conveniently be provided with dual-ear audio (i.e., music or voice) in a single compact design.

Memory 180 may contain processor-executable instruction sequences for operating the headset 100. The controller 130 may communicate with memory 180 via an address/data bus. It should be appreciated that the controller 130 may be any commercially available microcontroller or custom microprocessor. The memory 180 may include one or more read-only memories (ROM), erasable programmable ROMs (EPROM or Flash EPROM), battery backed random access memory (RAM), magnetic, optical, or other digital storage device, and may be separate from, or at least partially integral with the processor 130.

User controls 190 may be configured to enable various user inputs for accessing headset functions and for operating the headset 100 in general. It should be appreciated that user controls 190 may include buttons and/or switches relating to volume control, power control, menu access, music play/fast forward/rewind, etc. While not shown, it should further be appreciated that the headset 100 may include any or all additional components commonly found in wireless headset designs, such as a vibration motor, power source, LCD, LEDs, etc.

In one embodiment, headset 100 is a Bluetooth™-enabled earpiece which permits a user to communicate with another electronic device, such as a cellular telephone, PDA, etc. As will be discussed in more detail below, the headset 100 may be activated and operated using user controls 190. As is known in the art, the headset 100 may then be “paired” with or otherwise authenticated by one or more other communication devices (e.g., cellular telephone, PDA, etc.) using the first transceiver 110. In another embodiment, the headset 100 is further configured to receive a media data stream (e.g., music) from the user device 210 over the communication link 225. Music streaming may be temporarily halted to accommodate an incoming call.

FIG. 1B depicts a perspective view of one embodiment of the headset 100 of FIG. 1A. As shown, headset 100 includes the loudspeaker 150 in the form of an earbud. Loudspeaker 170 is depicted as being a retractable earbud which a user can extend and place in the ear opposite the side the headset 100 is on. In addition, user controls 190 include various buttons for controlling music playback, accessing a menu, etc. Similarly, FIG. 1C depicts another view of the headset 100 of FIG. 1B in which the second loudspeaker/earbud 170 is housed within enclosure 195.

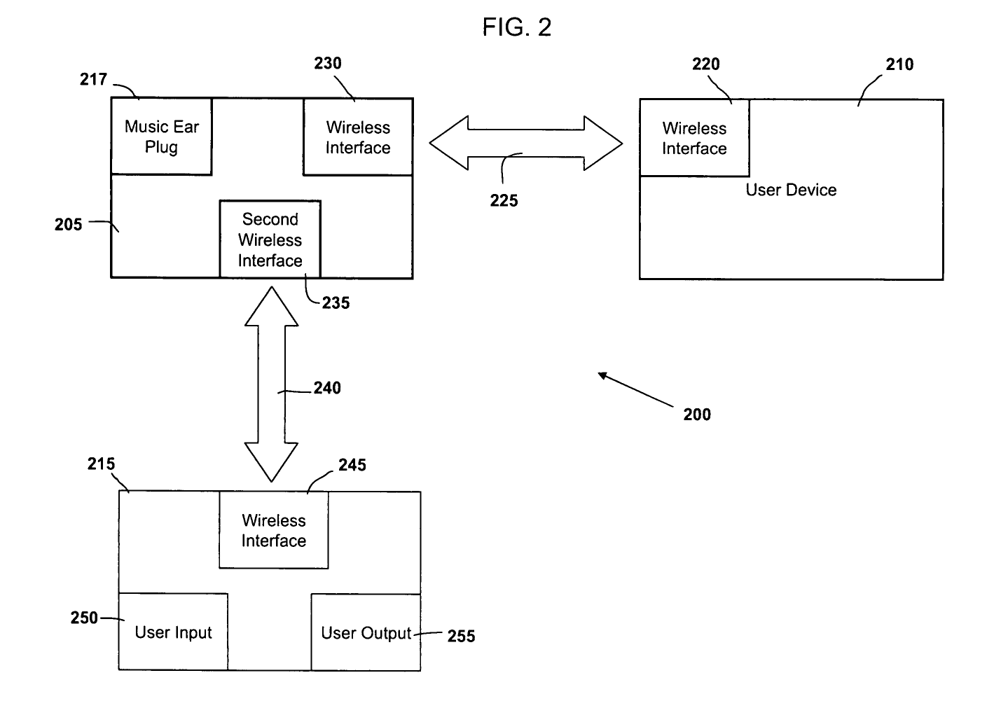

Referring now to FIG. 2, depicted is one embodiment of a communication system 200 which includes a wireless headset 205, a user device 210 and a wireless dialer 215. In one embodiment, the wireless headset is 205 is one embodiment of the headset 100 of FIGS. 1A-1B. To that end, although not shown, wireless headset 205 may further include one or more of the components described above with reference to FIG. 1A (e.g., microphone 140, loudspeakers 150, memory 180, user controls 190, etc.). The music ear plug 217 may be one embodiment of the second loudspeaker 170 depicted in FIGS. 1A-1B.

In certain embodiments, the user device 210 may be any personal electronic device (e.g., cellular phone, PDA, laptop, or other cellular-capable device) capable of wireless communication (e.g., Bluetooth™). In addition, user device 210 may be any cellular-capable device so as to enable headset 205 to be used as a communication device for cellular communication initiated by the user device 210.

User device 210 includes a wireless interface 220 for establishing a wireless communication link 225 to a corresponding wireless interface 230 of the wireless headset 205. In one embodiment, wireless interfaces 220 and 230 function as Bluetooth™ modules and communication link 225 is a Bluetooth™ connection. However, in alternate embodiments wireless interfaces 220 and 230 may enable any other form of RF communication.

As also shown, headset 205 is equipped with a second wireless interface 235. In one embodiment, this second wireless interface 235 is configured to establish a second communication link 240 with a corresponding wireless interface 245 of the wireless dialer 215. While in one embodiment the second communication link 240 may also be any RF-based signal, in another embodiment it may include an infrared-based signal.

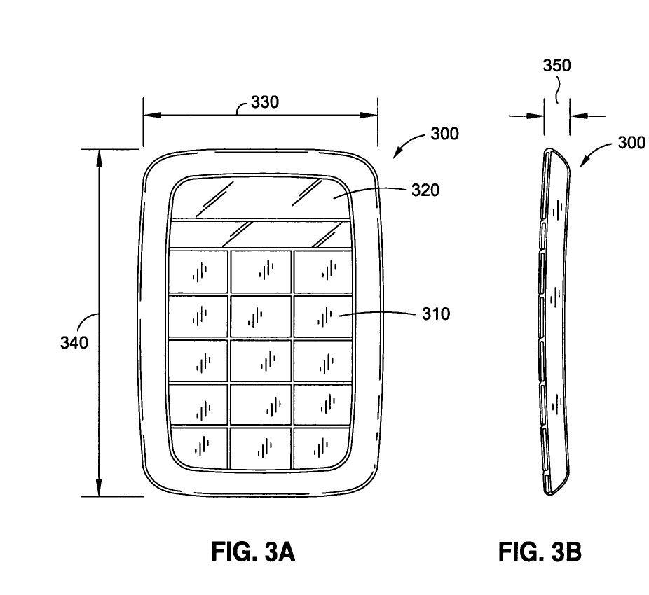

As will be described in more detail below with reference to FIGS. 3A-3B, in one embodiment the wireless dialer 215 may be a small and compact (e.g., credit card sized) device which includes a numeric keypad for entering a numeric sequence. The wireless dialer may be configured to enable a user to enter a telephone number using the user input 250 (e.g., keypad), and to transmit data representative of this telephone number to the headset 205 via communication link 240. Thereafter, the headset 205 may transmit the data to the user device 210 via communication link 225, which in turn uses the telephone number information to initiate a cellular telephone call. In this fashion, the wireless dialer 215 enables a user to use a conveniently small and compact device to wireless place a telephone call using a cellular-capable device (e.g., user device 210) which may not be as small or as conveniently located. User's would be free to leave their PDAs, smartphones, etc. in a stored location, and still be able to place a call via the wireless dialer 215 using only a credit-card sized keypad. Once the call is established, the headset 205 would enable handsfree two-way cellular communication.

FIG. 3A illustrates one embodiment of the wireless dialer 215 of FIG. 2. In this embodiment, wireless dialer 300 includes a keypad area 310 and a display 320. As previously mentioned, the wireless dialer 300 may be configured to enable a user to enter a telephone number using the keypad 310 and to transmit data representative of this telephone number to an corresponding headset (e.g., headset 205) via a communication link, such as an RF or infrared link. FIG. 3B depicts thin-form embodiment of the wireless dialer 300. In certain embodiments, the wireless dialer 300 may also be outfitted with music player functionality, including retractable headphones.

In certain embodiments, the dialer 215 may have a footprint of approximately the size of a business card. By way of example, the dialer 215 may have a width 330 of between 1 and 3 inches, and preferably about 2 inches. In addition, the dialer 215 may have a length 340 of between 1 and 5 inches, and preferable about 3 inches long. Finally, the dialer 215 may have a depth 350 of less than 1 inch, and preferably between 0.25 and 0.5 inches. It should be appreciated that in those embodiments where the dialer includes integrated music player functionality, the aforementioned dimensions may increase to accommodate the additional electrical components.

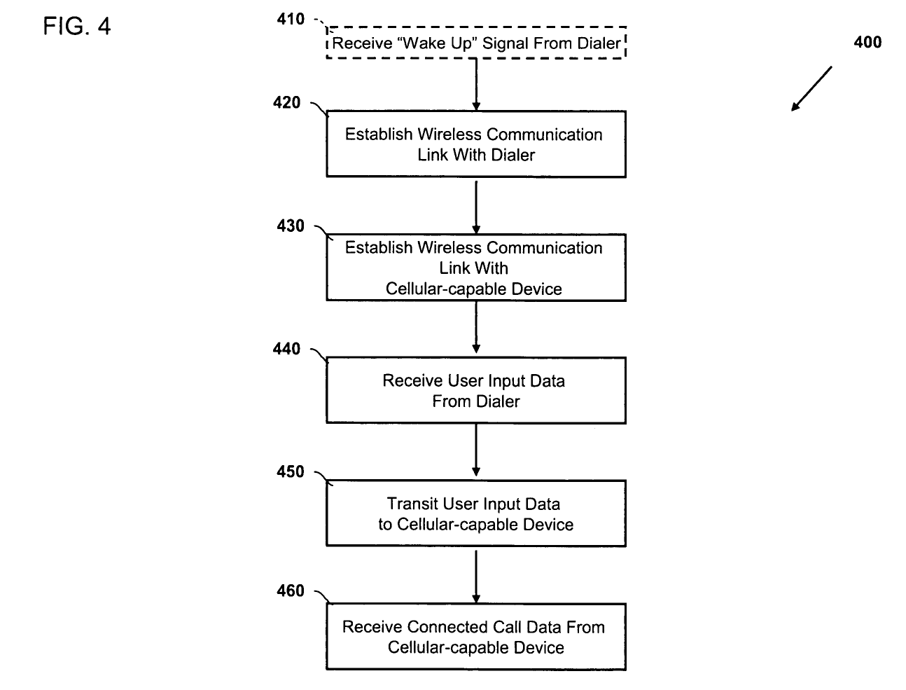

FIG. 4 is a flow diagram for a process of using a wireless headset in accordance with the principles of one embodiment of the invention. Process 400 assumes a cellular-capable device (e.g., user device 210) and a wireless headset (e.g., headset 205) have been “paired” or otherwise configured to recognize and accept communications from each other. Process 400 further assumes that the wireless headset has been configured to receive a wireless communication (e.g., communication link 240) from a wireless dialer (e.g., dialer 215).

With that, process 400 begins at block 410 with the wireless headset (e.g., headset 205) optionally receiving a “wake up” signal from the dialer (e.g., dialer 215). The “wake up” signal may be any known flag or other collection of bits usable to inform and/or prepare the headset for the fact that data is about to be transmitted to it. In systems where the headset is in a constant “ready-state” it may not be necessary to send such a “wake up” signal.

At block 420, a wireless communication link may then be established between the wireless dialer and the wireless headset to which it has previously been “paired” or otherwise associated. It should be appreciated that the “wake up” signal of block 410 may part of or in addition to the establishment of the communication link at block 420. While in one embodiment, the communication link established at block 420 is an RF link, it may also be an infrared link. In certain embodiments, this communication link will be encrypted and/or require the user to perform an authentication operation (such as entering a passkey during a setup mode).

Thereafter, at block 430, a second wireless communication link may also be established between the wireless headset and the cellular-capable device (e.g., user device 210). As previously mentioned, where both the headset and cellular-capable device are Bluetooth™-enabled, this link may be a Bluetooth™ connection, but may similarly be any other form of wireless connection. In another embodiment, the establishment of the communication link at block 430 may include or be preceded by a “wake up” signal sent from the wireless headset to the cellular-capable device. As with the previously discussed “wake up” signal, this signal may be any known flag or other collection of bits usable to inform and/or prepare the cellular-capable device that data is about to be transmitted to it. The “wake up” signal may be a signal generated by the dialer which is relayed by the headset, or it may be generated by the headset itself.

Process 400 continues to block 440 where user input data is received from the wireless dialer via the connection established at block 420. In one embodiment, the user input data may correspond to telephone number information entered by a user via the wireless dialer.

Once the user input data has been received, process 400 continues to block 450 where this data may in turn be provided to the cellular-capable device via the connection established above at block 430. Thereafter, the cellular-capable device may use the user input data received to place a cellular telephone call to the intended called party.

In the event that the cellular-capable device was successful in placing the call to the intended called party, process 400 may conclude with the headset receiving call connection data from the cellular-capable device. In one embodiment, such call connection data may include one or more of a busy tone, a ring tone, and a pre-recorded call status message. Once the call is connected, the wireless headset may continue to provide two-way wireless communication with the cellular-capable device in the normal course.

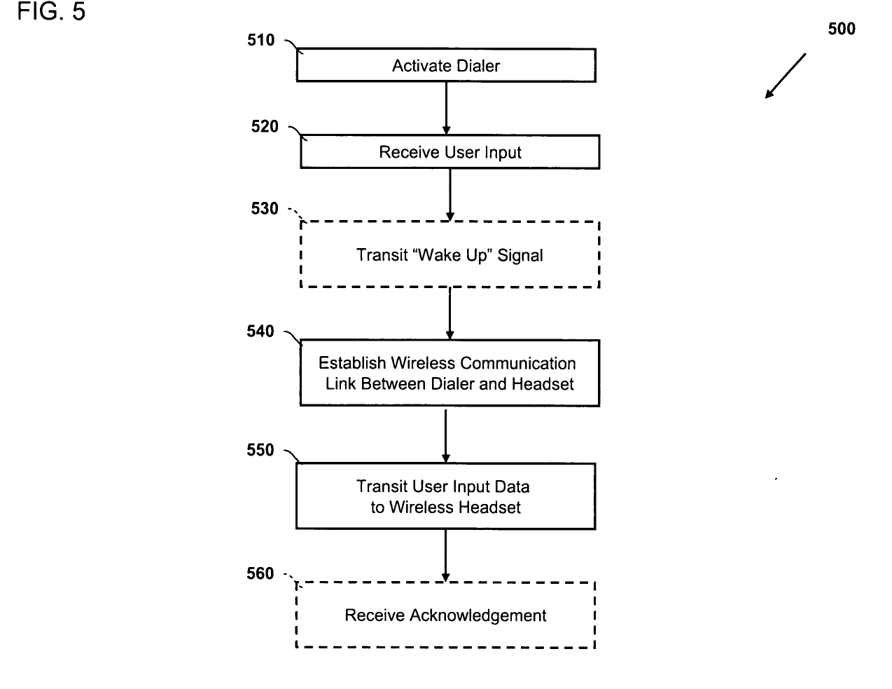

Referring now to FIG. 5, depicted is a flow diagram for a process of using a wireless dialer (e.g., wireless dialer 215) in accordance with the principles of one embodiment of the invention. Process 500 assumes a wireless headset (e.g., wireless headset 205) has been configured to at least receive a wireless communication (e.g., communication link 240) from the wireless dialer.

With that, process 500 begins at block 510 with the wireless dialer being activated by a user. It should be appreciated that this may be done by activating a power-on button for the dialer, through motion sensing, or any other known means for activating an electronic device. At block 520, the wireless dialer will receive user input information. In one embodiment, the user input includes entering a telephone number via an integrated keypad of the wireless dialer. At block 530, the dialer may transmit an optional “wake up” signal to the headset (e.g., headset 205). The “wake up” signal may be any known flag or other collection of bits usable to inform and/or prepare the headset for the fact that data is about to be transmitted to it. In systems where the headset is in a constant “ready-state” it may not be necessary to send such a “wake up” signal. In another embodiment, it should be appreciated that the operation of block 530 may precede the operation of block 520.

At block 540, a wireless communication link may then be established between the wireless dialer and the wireless headset to which it has previously been “paired” or otherwise associated. It should be appreciated that the “wake up” signal of block 530 may part of or in addition to the establishment of this communication link. While in one embodiment, the communication link established at block 540 is an RF link, it may also be an infrared link. In certain embodiments, this communication link will be encrypted and/or require the user to perform an authentication operation (such as entering a passkey during a setup mode).

Process 500 continues to block 550 where data representative of the previously-entered user input may be transmitted from the wireless dialer to the wireless headset via the connection established at block 540. In one embodiment, this information relates to the telephone number of an intended party to be called. Thereafter, an optional acknowledgement may be received at block 560 indicating that the user input data was received by the headset and/or an associated cellular-capable device.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A wireless headset comprising:
a first transceiver configured to establish a first wireless connection with the cellular-capable device, and
a second transceiver configured to establish a second wireless connection with a wireless dialer; and
a processor configured to cause the wireless headset to,
receive user communication data transmitted over the second wireless connection from the wireless dialer, and
transmit the user communication data over the first wireless connection to the cellular-capable device.

2. The wireless headset of claim 1, wherein the cellular-capable device is one of a cellular telephone, smartphone, personal digital assistant and a cellular-capable computer.

3. The wireless headset of claim 1, wherein the first wireless connection is a radio frequency connection established using an authentication operation.

4. The wireless headset of claim 1, wherein the wireless headset is a single-ear headset and includes a first earbud for positioning adjacent to a first user ear.

5. The wireless headset of claim 4, wherein the wireless headset further comprises a second earbud affixed to the wireless headset on a retractable connection line, said second earbud configured for positioning adjacent to a second user ear.

6. The wireless headset of claim 1, wherein the wireless dialer includes a display and a keypad for entering the user communication data.

7. The wireless headset of claim 1, wherein the user communication data includes a called party telephone number.

8. The wireless headset of claim 1, wherein the second wireless connection is one of a radio frequency communication link and an infrared communication link.

9. The wireless headset of claim 1, wherein the wireless headset is further configured to receive a media data stream from the cellular-capable device over the first wireless connection.

10. The wireless headset of claim 1, wherein the media data stream comprises a music stream.

11. A method of wireless communication using a wireless headset comprising:
establishing a first wireless connection with a wireless dialer;
establishing a second wireless connection with a cellular-capable device;
receiving user communication data over the first wireless connection;
transmitted the user communication data to the cellular-capable device using the second wireless connection; and
receiving call connection data from the cellular-capable device.

12. The method of claim 11, wherein establishing the second wireless connection comprises performing an authentication operation by sharing a passkey between the wireless headset and the cellular-capable device.

13. The method of claim 11, further comprising affixing an earbud to the wireless headset on a retractable connection line.

14. The method of claim 11, wherein the user communication data includes data representative of a called party telephone number.

15. The method of claim 11, wherein establishing the first wireless connection comprises establishing one of a radio frequency communication link and an infrared communication link.

16. The method of claim 11, further comprising receiving a media data stream from the cellular-capable device over the first wireless connection.

17. The method of claim 16, wherein the media data stream comprises a music stream.

18. The method of claim 11, wherein the call connection data includes one or more of a busy tone, ring tone and pre-recorded call status message.
